(19) United States
(12) Patent Application Publication
(10) Pub. No.: US 2012/0115526 A1
(43) Pub. Date: May 10, 2012

(54) RADIO BASE STATION AND RADIO COMMUNICATION METHOD

(75) Inventors: Yoshihiko Ogawa, Kanagawa (JP); Akihiko Nishio, Kanagawa (JP); Takashi Iwai, Ishikawa (JP); Seigo Nakao, Kanagawa (JP); Daichi Imamura, Kanagawa (JP)

(73) Assignee: PANASONIC CORPORATION, Osaka (JP)

(21) Appl. No.: 13/384,268

(22) PCT Filed: Aug. 6, 2010
(86) PCT No.: PCT/JP2010/004969

§ 371 Date: Jan. 16, 2012

(30) Foreign Application Priority Data
Aug. 7, 2009 (JP) 2009-184698

(51) Int. Cl. H04W 72/04; H04B 7/26

(52) U.S. Cl. 455/509

(57) ABSTRACT

Disclosed is a base station capable of minimizing in Type 0 assignment the number of resource block groups occupied by a terminal that performs frequency hopping, and thereby flexibly assigning resources in the Type 0 assignment. The base station (100) is used in a radio communication system in which a plurality of resource blocks constituting the system band thereof are grouped into resource block groups each consisting of P resource blocks, and the band that is not a PUCCH-assignable band to which PUCCHs assigned to both ends of the system band can be assigned is divided into a plurality of sub-bands. The base station (100) comprises an assignment unit (1102) and a demapping unit (112). The assignment unit (1102) assigns a plurality of resource blocks in units of resource block groups to terminal apparatuses to be subjected to noncontiguous-band assignment. The demapping unit (112) extracts, from a plurality of resource blocks in a second band, data signals for which frequencies are hopped by a frequency-hopping terminal apparatus from one to another of the plurality of sub-bands. Here, the bandwidth of each of the plurality of sub-bands is a natural-number multiple of P.

### TECHNICAL FIELD

The present invention relates to a radio base station apparatus and a radio communication method.

### BACKGROUND ART

3GPP LTE (3rd Generation Partnership Project Long Term Evolution) uplinks support only continuous band assignment of data signals. However, according to LTE, a radio base station apparatus (hereinafter simply referred to as “base station”) selects whether or not to perform frequency hopping of a transmission band to which a data signal transmitted by a radio terminal apparatus (hereinafter simply referred to as “terminal”) is assigned. When frequency hopping is performed, the terminal causes a transmission band to which the data signal is assigned to differ from one slot to another. For this reason, even when a data signal is assigned to a continuous band in each slot, frequency hopping causes the transmission band to which the data signal is assigned to differ from one slot to another, and it is thereby possible to obtain a frequency diversity effect.

In LTE, the base station notifies an offset to determine a band to which frequency hopping is applied to the terminal. In LTE, a bandwidth of the band to which, for example, a control channel (e.g., PUCCH (Physical Uplink Control CHannel)) of the system band is assigned is set as this offset. Here, control channels such as PUCCH are set at both ends of the system band. Thus, the terminal determines a frequency band after removing the frequency band indicated by the offset from both ends of the system band as a band to which frequency hopping is applied. Furthermore, the band to which frequency hopping is applied is divided into a plurality of subbands based on information regarding the number of partitions notified from the base station (subband information). The terminal then frequency-hops the transmission band of the data signal for every plurality of subbands. A hopping pattern in which the transmission band is frequency-hopped is defined in a long segment (e.g., frame unit) and the hopping pattern of frequency hopping differs between different cells.

On the other hand, LTE-A (LTE-Advanced) uplink, which is a developed version of LTE is studying the possibility of supporting assignment of a data signal to non-continuous bands to improve frequency scheduling effects. Assignment of a data signal to a non-continuous band is already applied to LTE downlinks and the LTE downlinks use Type0 assignment whereby a resource block (RB) assignment notification at the time of non-continuous band assignment is notified using a bitmap (e.g., see Non-Patent Literature 1). Since Type0 assignment can reduce the amount of signaling in RB assignment notification, even LTE-A uplinks are expected to use Type0 assignment to notify RB assignment at the time of non-continuous band assignment.

In Type0 assignment, a plurality of RBs making up the system band is grouped into a plurality of RB groups (RBG: Resource Block Group) for every P continuous RBs. The base station then sets a signaling bit (1 or 0) indicating whether or not resources are assigned to each terminal in RBG units. For example, the base station sets a signaling bit of RBG to be assigned as a transmission band of a certain terminal to 1 and sets the signaling bit of RBG not to be assigned as the transmission band of the certain terminal to 0. The base station then notifies the bitmap made up of signaling bits of each RBG to each terminal. On the other hand, the terminal judges that of the received bitmap, P RBs in RBG whose signaling bit is 1 are assigned as the transmission band of the terminal and P RBs in RBG whose signaling bit is 0 are not assigned as the transmission band of the terminal.

In an LTE downlink, as illustrated in FIG. 1, the number of RBs included in one RBG (hereinafter referred to as “RBG size”) (=P) changes depending on the bandwidth of the system band. As illustrated in FIG. 1, the greater the bandwidth of the system band, the greater the RBG size P becomes.

### CITATION LIST

### Non-Patent Literature

### NPL 1

7.1.6 TS36.213 v8.7.0“3GPP TSG RAN; Evolved Universal Terrestrial Radio Access (E-UTRA); Physical layer procedures

### SUMMARY OF INVENTION

### Technical Problem

However, when both frequency hopping and Type0 assignment are used in one system, the terminal that performs frequency hopping (hereinafter referred to as “frequency hopping terminal”) may uselessly occupy RBs corresponding to a plurality of RBGs in Type0 assignment. Hereinafter, this will be described more specifically. In the following descriptions, suppose the bandwidth of the system band is 50 RBs as illustrated in FIG. 2.

Furthermore, the base station designates 3 RBs for each of PUCCH regions set at both ends of the system band and assumes that the number of subbands obtained by dividing the band to which frequency hopping is applied is 4. Therefore, in FIG. 2, the base station sets a band other than the PUCCH regions of the system band, that is, a band to which frequency hopping is applied to 44 RBs (=50 RBs−(3 RBs×2)); RBs#3 to #46. Furthermore, as illustrated in FIG. 2, the base station divides the band to which frequency hopping is applied into four equal parts to set four subbands having a bandwidth (subband bandwidth) of 11 RBs; subband #0 (RBs#3 to #13), subband #1 (RBs#14 to #24), subband #2 (RBs#25 to #35) and subband #3 (RBs#36 to #46).

Furthermore, the base station notifies control information including an offset (3 RBs) corresponding to the PUCCH region and the number of subbands (4) to the frequency hopping terminal, and the frequency hopping terminal divides the band (RBs#3 to #46) to which the frequency hopping illustrated in FIG. 2 is applied to set four subbands #0 to #3 as with the base station. The frequency hopping terminal then frequency-hops the transmission band of the data signal to the neighboring subband. To be more specific, as illustrated in FIG. 2, the frequency hopping terminal frequency-hops the transmission band of the data signal by 11 RBs (corresponding to 1 subband) per slot, which is a transmission time unit.

Furthermore, in FIG. 2, suppose RBG size P in Type0 assignment is 3 RBs. Therefore, in FIG. 2, the base station and a terminal to which non-continuous band assignment is applied (hereinafter referred to as “non-continuous band assignment target terminal”) group a plurality of RBs in order starting from RB#0 to set 16 RBGs; RBGs#0 to #15. In FIG. 2, RBG#0 including RBs#0 to #2, and RBG#15 including RB#47, which are the PUCCH regions, are not assigned to the data signal of the non-continuous band assignment target terminal. That is, the base station designates RBGs#1 to #14 illustrated in FIG. 2 as RBGs assignable to the non-continuous band assignment target terminal.

As illustrated, for example, in FIG. 2, a case will be described where the base station assigns 2 RBs; RBs#3 and #4 to frequency hopping terminal UE#1 and assigns 2 RBs; RBs#30 and #31 to frequency hopping terminal UE#2 before frequency hopping (slot #1 illustrated in FIG. 2).

In this case, after frequency hopping (slot #2 illustrated in FIG. 2), UE#1 is assigned to RBs#14 and #15 frequency-hopped by 11 RBs from RBs#3 and #4 (that is, frequency-hopped by 1 subband) respectively. Similarly, UE#2 is assigned to RBs#41 and #42 frequency-hopped by 11 RBs from RBs#30 and #31. Furthermore, UE#1 and UE#2 also repeat frequency hopping in slots (not illustrated) after slot #2 illustrated in FIG. 2 in the same way as frequency hopping of slot #1 and slot #2 illustrated in FIG. 2. That is, UE#1 (or UE#2) is assigned to RBs#3 and #4 (or RBs#30 and #31) in odd-numbered slots as in the case of slot #1 illustrated in FIG. 2 and assigned to RBs#14 and #15 (or RBs#41 and #42) in even-numbered slots as in the case of slot #2 illustrated in FIG. 2.

That is, frequency hopping terminals UE#1 and UE#2 occupy RBs#3, #4, #14, #15, RBs#30, #31, #41 and #42 of the system band illustrated in FIG. 2.

On the other hand, in Type0 assignment, the base station uses RBGs not including RBs#3, #4, #14, #15, #30, #31, #41 and #42 assigned to frequency hopping terminals UE#1 and UE#2 among RBGs#1 to #14 assignable to the non-continuous band assignment target terminal. To be more specific, as illustrated in FIG. 2, the base station cannot assign (unassignable) RBG#1 including RBs#3 and #4, RBG#4 including RB#14, RBG#5 including RB#15, RBG#10 including RBs#30 and #31, RBG#13 including RB#41 and RBG#14 including RB#42 among RBGs#1 to #14 to the non-continuous band assignment target terminal. That is, the base station can assign eight RBGs of RBGs#2, #3, #6 to #9, #11 and #12 illustrated in FIG. 2 to the non-continuous band assignment target terminal.

Here, the number of RBs assigned to frequency hopping terminals UE#1 and UE#2 is assumed to be 2 per slot each. When a speech communication terminal (VoIP terminal) is assumed, the number of RBs assigned to each terminal is highly likely to be 1 to 3 RBs. Therefore, the number of RBs assigned to each terminal (UE#1 and UE#2) is assumed to be 2 RBs, which is an intermediate value of the number of RBs (1 to 3 RBs) highly likely to be assigned. In this case, RBs assigned to frequency hopping terminals UE#1 and UE#2 in each slot have an RBG size of P (=3 RBs) or below in Type0 assignment. That is, in FIG. 2, each frequency hopping terminal occupies only 2 RBs, which is equal to or below the RBG size (=3 RBs) in Type0 assignment. Thus, the base station assigns only RBs (RBs#3 and #4 in FIG. 2) included in 1 RBG (RBG#1 in FIG. 2) in Type0 assignment in slot #1 before frequency hopping to UE#1. The same applies to UE#2 illustrated in FIG. 2.

However, as illustrated in FIG. 2, in slot #2 after frequency hopping, RB#14 and RB#15 assigned to UE#1 are included in mutually different RBG#4 and RBG#5 respectively. That is, in slot #2 illustrated in FIG. 2, two RBs (RBs#14 and #15) assigned to UE#1 are assigned over two RBGs (RBGs#4 and #5) though the two RBs have the number of RBs that falls within one RBG in Type0 assignment. The same applies to UE#2 illustrated in FIG. 2.

That is, in slot #2 after the frequency hopping illustrated in FIG. 2, although only two RBs, which is equal to or below RBG size P (=3 RBs) in Type0 assignment, are assigned to each frequency hopping terminal, RBs are assigned to two RBGs. That is, the frequency hopping terminal uselessly occupies a plurality of RBGs in Type0 assignment.

By this means, even when RBs corresponding to RBs within one RBG in Type0 assignment are assigned to the frequency hopping terminal before frequency hopping, RBs corresponding to a plurality of RBGs in Type0 assignment may be assigned after the frequency hopping. In this case, RBGs in Type0 assignment may be uselessly occupied by RBs occupied by the frequency hopping terminal, making it impossible to flexibly assign resources in Type0 assignment.

It is an object of the present invention to provide a radio base station apparatus and a radio communication method capable of reducing the number of RBGs occupied in Type° assignment by a terminal that performs frequency hopping and flexibly assigning resources in Type0 assignment.

### Solution to Problem

A radio base station apparatus according to the present invention is a radio base station apparatus used in a radio communication system in which a plurality of resource blocks consisting of a system band are grouped into a plurality of resource block groups for every P resource blocks and a second band other than a first band to which control channels assigned at both ends of the system band can be assigned is divided into a plurality of subbands, and adopts a configuration including an assignment section that assigns the plurality of resource blocks to a terminal apparatus assigned a non-continuous band in units of the resource block groups and an extraction section that extracts a data signal frequency-hopped by a frequency hopping terminal apparatus for every plurality of subbands from the plurality of resource blocks in the second band, wherein each bandwidth of the plurality of subbands is a natural number multiple of P.

A radio communication method according to the present invention is a radio communication method used in a radio communication system in which a plurality of resource blocks consisting of a system band are grouped into a plurality of resource block groups for every P resource blocks and a second band other than a first band to which control channels assigned at both ends of the system band can be assigned is divided into a plurality of subbands, the method including a step of assigning the plurality of resource blocks to a terminal apparatus assigned a non-continuous band in units of the resource block groups and a step of extracting a data signal frequency-hopped by a frequency hopping terminal apparatus for every plurality of subbands from the plurality of resource blocks in the second band, wherein each bandwidth of the plurality of subbands is a natural number multiple of P.

### Advantageous Effects of Invention

The present invention can reduce the number of RBGs occupied by a terminal that performs frequency hopping in Type0 assignment and flexibly assigning resources in Type0 assignment.

### BRIEF DESCRIPTION OF DRAWINGS

FIG. 1 illustrates a relationship between a bandwidth of a system band and an RBG size of Type0 assignment in LTE;

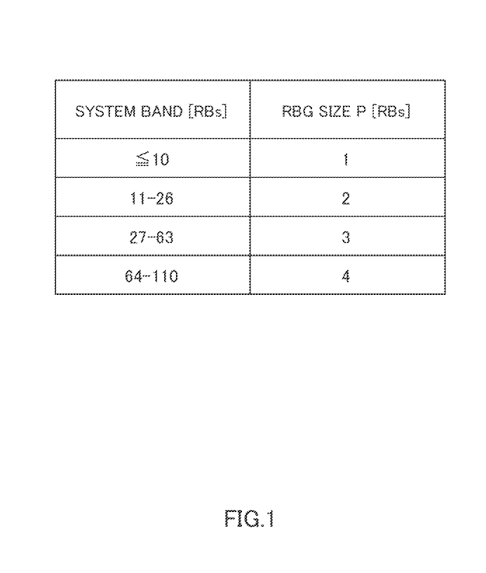

FIG. 2 illustrates RBGs that cannot be assigned in Type0 assignment when frequency hopping and Type0 assignment are used;

FIG. 3 is a block diagram illustrating a configuration of a base station according to Embodiment 1 of the present invention;

FIG. 4 is a block diagram illustrating a configuration of a terminal according to Embodiment 1 of the present invention;

FIG. 5 illustrates an example of setting subbands and RBGs according to Embodiment 1 of the present invention;

FIG. 6 illustrates RBs that cannot be assigned to a frequency hopping terminal;

FIG. 7 illustrates an example of setting subbands and RBGs according to Embodiment 2 of the present invention;

FIG. 8 illustrates another example of setting subbands and RBGs according to Embodiment 2 of the present invention;

FIG. 9 illustrates a further example of setting subbands and RBGs according to Embodiment 2 of the present invention;

FIG. 10 illustrates a still further example of setting subbands and RBGs according to Embodiment 2 of the present invention;

FIG. 11 illustrates a still further example of setting subbands and RBGs according to Embodiment 2 of the present invention;

FIG. 12 illustrates an example of setting subbands and RBGs according to Embodiment 3 of the present invention; and

FIG. 13 illustrates another example of setting subbands and RBGs according to Embodiment 3 of the present invention.

### DESCRIPTION OF EMBODIMENTS

Hereinafter, embodiments of the present invention will be described in detail with reference to the accompanying drawings.

A communication system according to the present invention includes a mixture of terminals (frequency hopping terminal) that frequency-hop a transmission band of a data signal (uplink data) assigned to a continuous band and terminals (non-continuous band assignment target terminals) in which a data signal (uplink data) is assigned to a non-continuous band.

In the following descriptions, a plurality of RBs making up a system band are grouped into a plurality of RBGs for every P RBs. A case will be described as an example where the base station assigns, for example, a plurality of RBs to a non-continuous band assignment target terminal in RBG units as in the case of Type0 assignment and notifies resource assignment information indicating a signaling bit (1 or 0) illustrating whether or not RBGs for transmitting a data signal are assigned to each terminal.

Furthermore, the base station notifies an offset to determine a band to which frequency hopping is applied to the frequency hopping terminal. Here, frequency hopping is applied to a band other than bands (hereinafter referred to as “PUCCH assignable regions”) to which control channels such as PUCCH are assignable out of the system band. Therefore, in the following descriptions, the offset to determine the band to which frequency hopping is applied is set to the same bandwidth as that of the PUCCH assignable region. Furthermore, the band to which frequency hopping is applied is uniformly divided into a plurality of subbands. The frequency hopping terminal frequency-hops the transmission band of the data signal for every plurality of subbands. That is, a subband is a minimum unit of frequency interval when the transmission band of the data signal is frequency-hopped.

### Embodiment 1

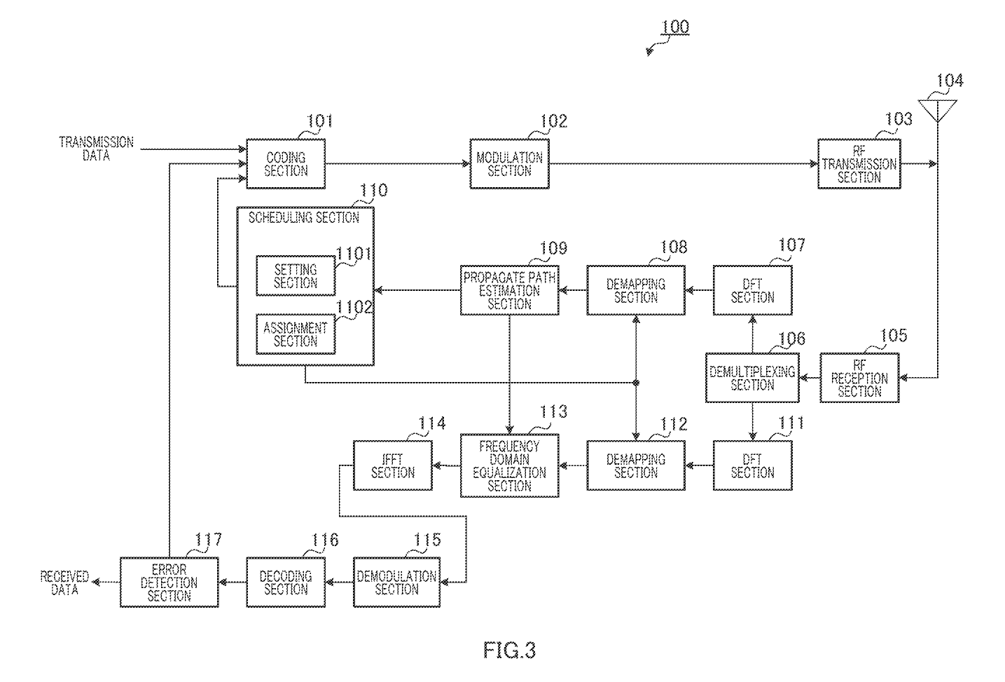

A configuration of base station 100 according to an embodiment of the present invention will be described using FIG. 3.

In base station 100 illustrated in FIG. 3, coding section 101 receives as input transmission data (downlink data). Furthermore, coding section 101 also receives as input a response signal (ACK (Acknowledgment) signal or NACK (Negative Acknowledgment) signal) from error detection section 117, and receives as input resource assignment information indicating RBs assigned to each terminal, hopping information indicating information on the band to which frequency hopping is applied and control information such as MCS (Modulation Coding Schemes) from scheduling section 110. Coding section 101 then codes the transmission data and control information and outputs the coded data to modulation section 102.

Modulation section 102 modulates the coded data and outputs the modulated signal to RF (Radio Frequency) transmission section 103.

RF transmission section 103 applies transmission processing such as D/A conversion, up-conversion, amplification to the modulated signal and transmits the signal subjected to the transmission processing from antenna 104 to each terminal by radio.

RF reception section 105 applies reception processing such as down-conversion, A/D conversion to a signal received via antenna 104 and outputs the signal subjected to the reception processing to demultiplexing section 106.

Demultiplexing section 106 separates the signal inputted from RF reception section 105 into a pilot signal and a data signal. Demultiplexing section 106 then outputs the pilot signal to DFT (Discrete Fourier Transform) section 107 and outputs the data signal to DFT section 111.

DFT section 107 applies DFT processing to the pilot signal inputted from demultiplexing section 106 to transform the pilot signal from a time domain signal to a frequency domain signal. DFT section 107 then outputs the pilot signal transformed into the frequency domain to demapping section 108.

Demapping section 108 extracts a pilot signal of a portion corresponding to a transmission band of each terminal from the pilot signal in the frequency domain inputted from DFT section 107 based on information inputted from scheduling section 110. Demapping section 108 outputs each extracted pilot signal to propagation path estimation section 109.

Propagation path estimation section 109 estimates an estimation value of a frequency variation of a channel (frequency response of the channel) and an estimation value of receiving quality based on the pilot signal inputted from demapping section 108. Propagation path estimation section 109 then outputs the estimation value of the frequency variation of the channel to frequency domain equalization section 113 and outputs the estimation value of the receiving quality to scheduling section 110.

Scheduling section 110 is provided with setting section 1101 and assignment section 1102. Setting section 1101 of scheduling section 110 sets a PUCCH assignable region to which a control channel such as PUCCH of the system band may be assigned and the number of a plurality of sub bands making up a band to which frequency hopping is applied. Here, setting section 1101 sets the PUCCH assignable region and the number of subbands so that the subband bandwidth obtained by dividing the band to which frequency hopping is applied becomes a natural number multiple of RBG size P in Type0 assignment. Setting section 1101 then determines the band to which frequency hopping is applied and the subband bandwidth based on the PUCCH assignable region and the number of subbands. Setting section 1101 then outputs information indicating the band to which frequency hopping is applied and the subband bandwidth to demapping section 108 and demapping section 112. Furthermore, setting section 1101 generates hopping information including an offset corresponding to the bandwidth of the set PUCCH assignable regions and the number of subbands, and outputs the hopping information generated to coding section 101.

Assignment section 1102 of scheduling section 110 assigns RBs to each terminal using the estimation value of the receiving quality inputted from propagation path estimation section 109. To be more specific, assignment section 1102 assigns some RBs making up a continuous band to which frequency hopping is applied determined in setting section 1101 to the frequency hopping terminal. Furthermore, assignment section 1102 assigns a plurality of RBs making up the system band to the non-continuous band assignment target terminal apparatus in RBG units. Assignment section 1102 also assigns RBs to terminals that do not perform frequency hopping. Assignment section 1102 then outputs information of assigned RBs of each terminal indicating RBs assigned to each terminal to demapping section 108 and demapping section 112. Furthermore, assignment section 1102 generates resource assignment information indicating the information of assigned RBs and outputs the resource assignment information generated to coding section 101. For example, assignment section 1102 generates a bitmap that sets a signaling bit (1 or 0) indicating whether or not an RBG including assigned RBs is assigned to the transmission band for the non-continuous band assignment target terminal as resource assignment information.

On the other hand, DFT section 111 applies DFT processing to the data signal inputted from demultiplexing section 106 to transform the data signal from a time domain signal to a frequency domain signal. DFT section 111 then outputs the data signal transformed into the frequency domain to demapping section 112.

Demapping section 112 extracts a data signal of a portion corresponding to the transmission band of each terminal from the signal inputted from DFT section 111 based on the information inputted from scheduling section 110. For example, demapping section 112 extracts the data signal frequency-hopped for every plurality of subbands by the frequency hopping terminal from a plurality of RBs in the band to which frequency hopping is applied, based on information indicating the band to which frequency hopping is applied and the subband bandwidth, the information inputted from scheduling section 110. Alternatively, demapping section 112 extracts the data signal transmitted from the non-continuous band assignment target terminal in RBG units from a plurality of RBs in the system band, based on the information of assigned RBs, the information inputted from scheduling section 110. Demapping section 112 outputs each extracted signal to frequency domain equalization section 113.

Frequency domain equalization section 113 applies equalization processing to the data signal inputted from demapping section 112 using the estimation value of a frequency variation in the channel inputted from propagation path estimation section 109 and outputs the signal after the equalization processing to IFFT (Inverse Fast Fourier Transform) section 114.

IFFT section 114 applies IFFT processing to the data signal inputted from frequency domain equalization section 113 and outputs the signal after the IFFT processing to demodulation section 115.

Demodulation section 115 applies demodulation processing to the signal inputted from IFFT section 114 and outputs the signal after the demodulation processing to decoding section 116.

Decoding section 116 applies decoding processing to the signal inputted from demodulation section 115 and outputs the signal after the decoding processing (decoded bit sequence) to error detection section 117.

Error detection section 117 performs error detection on the decoded bit sequence inputted from decoding section 116. For example, error detection section 117 performs error detection using CRC (Cyclic Redundancy Check). When the error detection result illustrates the presence of an error in the decoded bit, error detection section 117 generates a NACK signal as a response signal or generates an ACK signal as the response signal when no error is found in the decoded bit. Error detection section 117 then outputs the response signal generated to coding section 101. Furthermore, when no error is found in the decoded bit, error detection section 117 outputs the data signal as the received data.

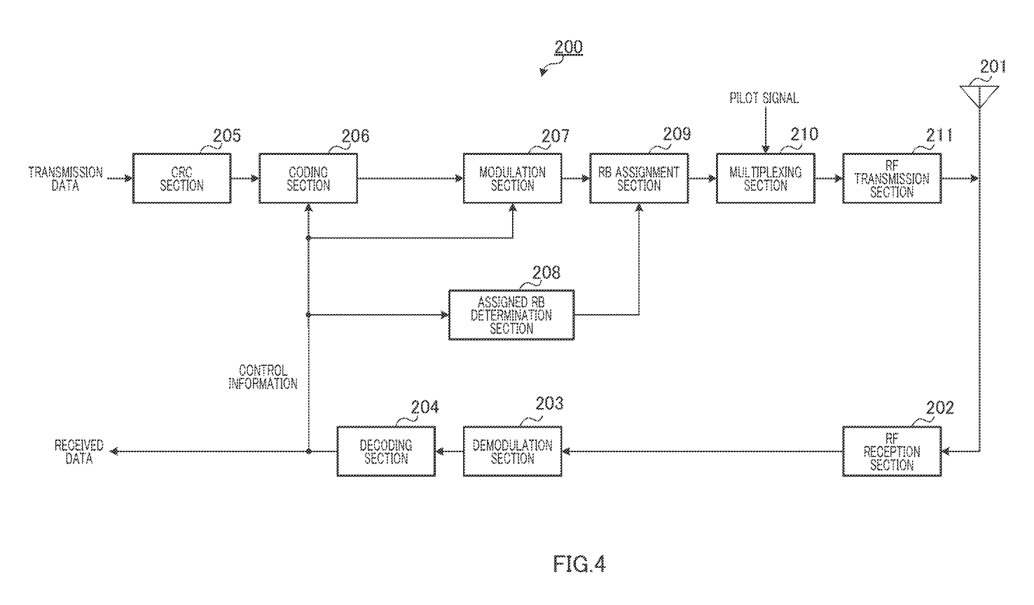

Next, the configuration of terminal 200 according to the embodiment of the present invention will be described using FIG. 4.

In terminal 200 illustrated in FIG. 4, RF reception section 202 applies reception processing such as down-conversion, A/D conversion to a signal from base station 100 (FIG. 3) received via antenna 201 and outputs the signal subjected to the reception processing to demodulation section 203.

Demodulation section 203 applies equalization processing and demodulation processing to the signal inputted from RF reception section 202 and outputs the signal after this processing to decoding section 204.

Decoding section 204 applies decoding processing to the signal inputted from demodulation section 203 and extracts received data and control information. Here, the control information includes a response signal (ACK signal or NACK signal), resource assignment information, hopping information, MCS information or the like. Of the extracted control information, decoding section 204 outputs the resource assignment information and hopping information to assigned RB determination section 208 and outputs the MCS information or the like to coding section 206 and modulation section 207.

Transmission data is inputted to CRC section 205. CRC section 205 performs CRC coding on the inputted transmission data to generate CRC coded data and outputs the CRC coded data generated to coding section 206.

Coding section 206 codes the CRC coded data inputted from CRC section 205 based on control information such as the MCS information inputted from decoding section 204 and outputs the coded data obtained to modulation section 207.

Modulation section 207 modulates the coded data inputted from coding section 206 based on the control information such as the MCS information inputted from decoding section 204 and outputs the modulated data signal to RB assignment section 209.

When resource assignment to the terminal is continuous band assignment (that is, terminal 200 is a frequency hopping terminal), assigned RB determination section 208 determines a band to which frequency hopping is applied and bandwidths of a plurality of subbands obtained by dividing the band to which frequency hopping is applied based on an offset (corresponding to the PUCCH assignable region) and the number of subbands included in the hopping information inputted from decoding section 204. Assigned RB determination section 208 then determines RBs (assigned RBs) assigned as a transmission band of the terminal by frequency-hopping RBs (transmission band of the data signal) indicated by the resource assignment information inputted from decoding section 204 for each slot, which is the transmission time unit, for every plurality of subbands. Assigned RB determination section 208 then outputs the assigned RB information indicating the determined RBs to RB assignment section 209.

On the other hand, when resource assignment to the terminal is non-continuous band assignment (that is, terminal 200 is a non-continuous band assignment target terminal), assigned RB determination section 208 determines RBs (assigned RBs) assigned to the terminal, based on resource assignment information (bitmap) inputted from decoding section 204. To be more specific, assigned RB determination section 208 determines RBs included in RBG whose signaling is 1 in the bitmap indicated by the resource assignment information, as RBs assigned as the transmission band of the terminal. Assigned RB determination section 208 then outputs the assigned RB information indicating the determined RBs to RB assignment section 209.

RB assignment section 209 applies DFT processing to the data signal inputted from modulation section 207 to transform the data signal from a time domain signal to a frequency domain signal. RB assignment section 209 then assigns the data signal after the DFT processing to RBs, based on the assigned RB information inputted from assigned RB determination section 208. RB assignment section 209 then applies IFFT processing to the data signal assigned to RBs and outputs the data signal after the IFFT processing to multiplexing section 210.

Multiplexing section 210 time-multiplexes a pilot signal with the data signal inputted from RB assignment section 209 and outputs the multiplexed signal to RF transmission section 211.

RF transmission section 211 applies transmission processing such as D/A conversion, up-conversion, amplification to the multiplexed signal inputted from multiplexing section 210 and transmits the signal subjected to the transmission processing from antenna 201 to base station 100 (FIG. 3) by radio.

Next, operations of base station 100 (FIG. 3) and terminal 200 (FIG. 4) according to the present embodiment will be described in detail.

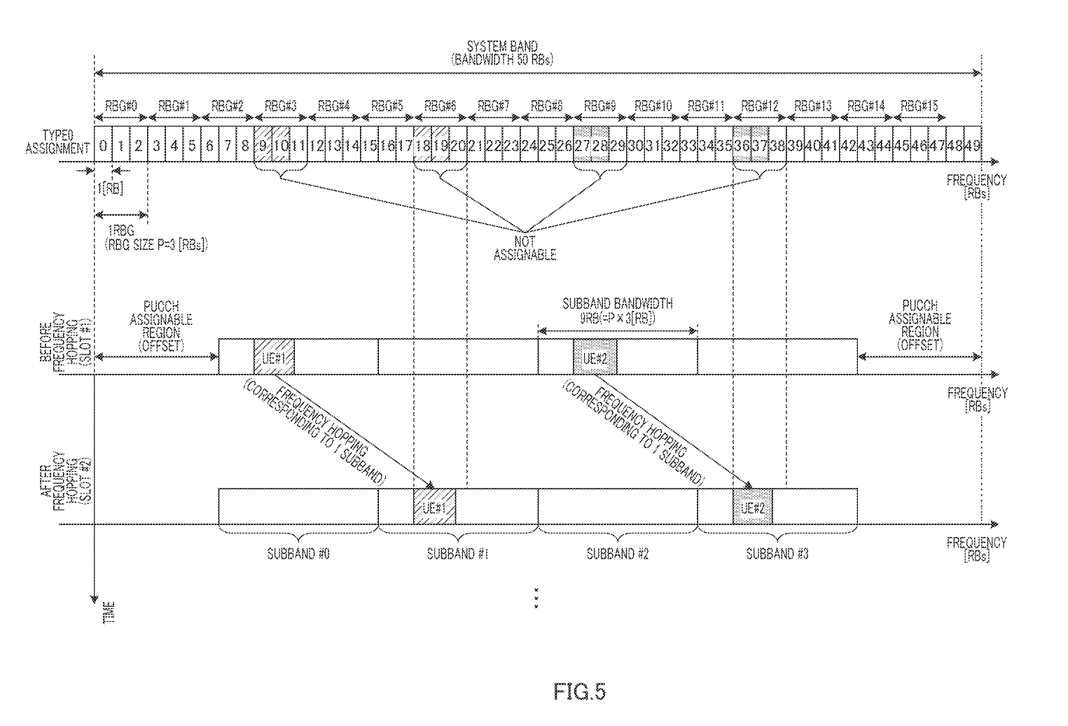

In the following descriptions, as illustrated in FIG. 5, suppose the bandwidth of the system band is 50 RBs (e.g., 10 MHz). Furthermore, in FIG. 5, suppose 3 RBs at both ends of the system band are designated as PUCCH regions. Furthermore, suppose RBG size P in Type0 assignment is 3 RBs.

Thus, in FIG. 5, a plurality of RBs are grouped into RBGs#0 to #15 for every P RBs in order starting from RB#0. However, since RBGs#0 and #15 include RBs making up the PUCCH regions, they are not assigned to a data signal of a non-continuous band assignment target terminal. That is, base station 100 designates RBGs#1 to #14 illustrated in FIG. 5 as RBGs assignable to the non-continuous band assignment target terminal.

Here, setting section 1101 of scheduling section 110 of base station 100 sets the PUCCH assignable regions and the number of subbands such that the bandwidth of each of a plurality of subbands generated by dividing the band to which frequency hopping is applied becomes a natural number multiple of RBG size P.

For example, setting section 1101 sets the PUCCH assignable region to 7 RBs and sets the number of subbands to 4. Setting section 1101 then sets the band to which frequency hopping is applied and the subband bandwidth, based on the PUCCH assignable region of 7 RBs and the number of subbands of 4.

To be more specific, as illustrated in FIG. 5, setting section 1101 sets 7 RBs (RBs#0 to #6 and RBs#43 to #49) at both ends of the system band (50 RBs) as the PUCCH assignable regions first. Thus, as illustrated in FIG. 5, setting section 1101 sets the band other than the PUCCH assignable regions of the system band (50 RBs), that is, 36 RBs (=50 RBs−(7 RBs×2)) of RBs#7 to #42 as the band to which frequency hopping is applied. Furthermore, since the number of subbands is 4, setting section 1101 uniformly divides the band to which frequency hopping is applied (36 RBs) into four subbands #0 to #3 each having a bandwidth (subband bandwidth) of 9 RBs (=36 RBs/4). Thus, each bandwidth (9 RBs) of subbands #0 to #3 is a natural number multiple of (3 times) RBG size P (3 RBs).

When resource assignment of the terminal is continuous band assignment (when terminal 200 is a frequency hopping terminal), assigned RB determination section 208 of terminal 200 (FIG. 4) determines the band to which frequency hopping is applied (36 RBs) and the subband bandwidth (9 RBs) using the offset (corresponding to the PUCCH assignable region, 7 RBs in FIG. 5) and the number of subbands (4 subbands) notified from base station 100 as in the case of setting section 1101. Thus, RB assignment section 209 of terminal 200 (frequency hopping terminal) frequency-hops the transmission band of a data signal by one subband (9 RBs in FIG. 5) per slot, that is, three times the RBG size in Type0 assignment.

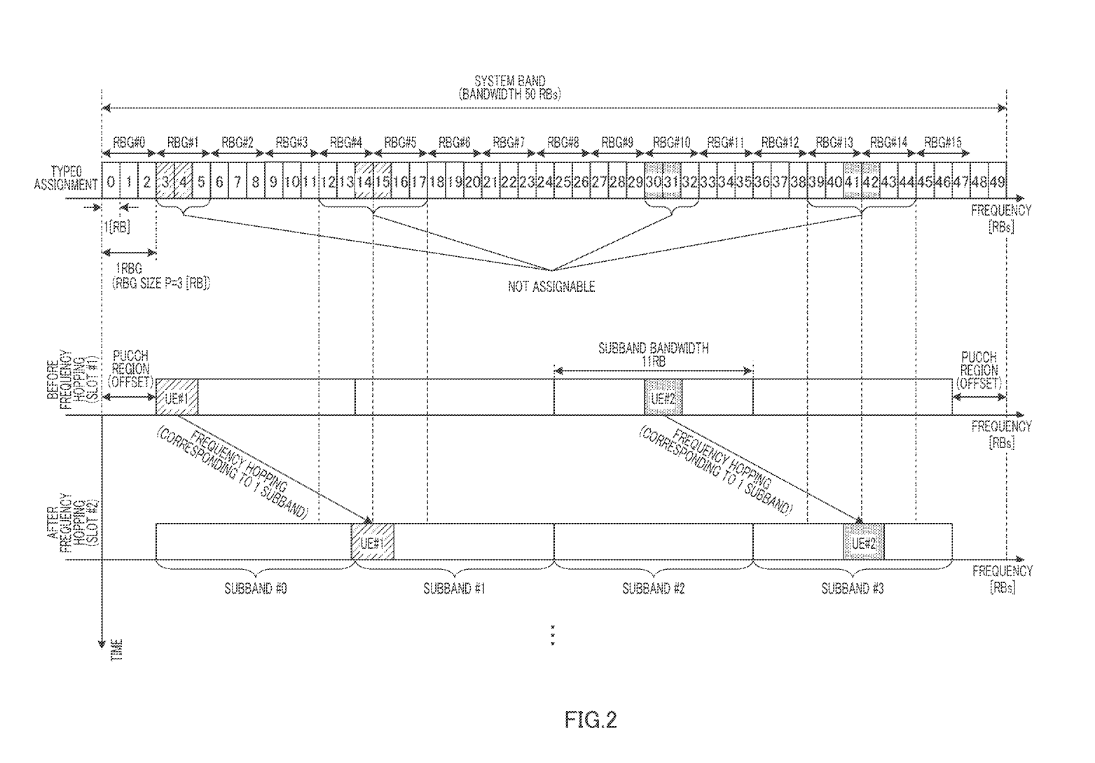

Next, a case will be described as illustrated in FIG. 5, where base station 100 assigns 2 RBs; RBs#9 and #10 to frequency hopping terminal UE#1 before frequency hopping (slot #1 illustrated in FIG. 2) and assigns 2 RBs; RBs#27 and #28 to frequency hopping terminal UE#2.

In this case, after frequency hopping (slot #2 illustrated in FIG. 5), UE#1 is assigned to RBs#18 and #19 frequency-hopped by 9 RBs from RBs#9 and #10 (that is, frequency-hopped by one subband). Similarly, UE#2 is assigned to RBs#36 and #37 frequency-hopped by 9 RBs from RBs#27 and #28. Furthermore, UE#1 and UE#2 repeat frequency hopping in slots (not illustrated) after slot #2 illustrated in FIG. 5 in the same way as slot #1 and slot #2 illustrated in FIG. 5.

That is, frequency hopping terminals UE#1 and UE#2 occupy RBs#9, #10, #18, #19, RBs#27, #28, #36 and #37 of the system band illustrated in FIG. 5.

Thus, assignment section 1102 of base station 100 uses RBGs not including RBs#9, #10, #18, #19, #27, #28, #36 and #37 assigned to frequency hopping terminals UE#1 and UE#2 (that is, RBGs other than RBGs#3, #6, #9 and #12) of RBGs#1 to #14 assignable to the non-continuous band assignment target terminal in Type0 assignment. That is, assignment section 1102 can assign 10 RBGs of RBGs#1, #2, #4, #5, #7, #8, #10, #11, #13 and #14 illustrated in FIG. 5 to the non-continuous band assignment target terminal.

Here, the transmission band of the data signal transmitted by frequency hopping terminals UE#1 and UE#2 (2 RBs per slot for each terminal) occupies only one RBG in Type0 assignment before and after frequency hopping as illustrated in FIG. 5. For example, UE#1 occupies only RBs#9 and #10 included in RBG#3 in slot #1 (before frequency hopping) illustrated in FIG. 5 and also occupies only RBs#18 and #19 included in RBG#6 in slot #2 (after frequency hopping) illustrated in FIG. 5. The same applies to UE#2 illustrated in FIG. 5.

That is, RBs assigned to the frequency hopping terminal after frequency hopping are no longer assigned over a plurality of RBGs. This makes it possible to reduce the number of RBGs occupied by RBs assigned to the frequency hopping terminal in Type0 assignment. Thus, base station 100 can secure more RBGs assignable to the non-continuous band assignment target terminal in Type0 assignment. That is, base station 100 can improve flexibility of resource assignment in Type0 assignment.

Thus, according to the present embodiment, the subband bandwidth in frequency hopping is set to be a natural number multiple of the RBG size in Type0 assignment. That is, the frequency interval of a transmission band to which a data signal is assigned before and after frequency hopping is a natural number multiple of the RBG size. In this way, the data signal assigned so as to occupy only one RBG before frequency hopping is also assigned by occupying only one RBG after frequency hopping.

In other words, the RB configuration of RBG in Type0 assignment is identical between subbands. To be more specific, subband #0 illustrated in FIG. 5 is made up of last 2 RBs (RBs#7 and #8) of RBG#2, all 3 RBs of RBGs#3 and #4 (RBs#9 to #14) and first 1 RB (RB#15) of RBG#5, a total of 9 RBs in Type0 assignment. Similarly, subband #1 illustrated in FIG. 5 is made up of last 2 RBs (RBs#16 and #17) of RBG#5, all 3 RBs (RBs#18 to #23) of RBGs#6 and #7 and first 1 RB (RB#24) of RBG#8, a total of 9 RBs in Type0 assignment. The same applies to subband #2 and subband #3.

That is, 9 RBs making up subbands #0 to #3 correspond to 9 RBs over 4 RBGs in Type0 assignment illustrated in FIG. 5. Furthermore, a breakdown of respective RBs of 4 RBGs of 9 RBs making up each subband is [last 2 RBs, all 3 RBs, all 3 RBs, first 1 RB] in order starting from the start RBG (RBG of the smallest RBG number). That is, the band to which frequency hopping is applied (RB#7 to RB#42 in FIG. 5) has a configuration repeating the configuration of 9 RBs over 4 RBGs (breakdown: [last 2 RBs, all 3 RBs, all 3 RBs, first 1 RB]) four times (that is, 4 subbands).

Thus, even when the transmission band of a data signal is frequency-hopped for every plurality of subbands (frequency-hopped by one subband (9 RBs) in FIG. 5), the positions of RBs in RBGs to which the data signal is assigned before frequency hopping are identical to the positions of RBs in RBGs to which the data signal is assigned after frequency hopping. In other words, the positions of RBs to which the data signal is assigned before and after frequency hopping are identical to the positions in two RBGs located apart by a natural number (3 in FIG. 5) in Type0 assignment. For example, in FIG. 5, the positions of RBs to which the data signal of UE#1 is assigned are first 2 RBs (RBs#9 and #10 in RBG#3 and RBs#18 and #19 in RBG#6) in two RBGs; RBG#3 and RBG#6 located by three RBGs apart from RBG#3. Therefore, the data signal assigned so as to occupy only one RBG before frequency hopping is also assigned so as to occupy only one RBG after frequency hopping. In this way, when RBs are assigned within one RBG to the frequency hopping terminal before frequency hopping in Type0 assignment, RBs are not assigned over a plurality of RBGs after frequency hopping, making it possible to reduce the number of RBGs occupied.

Thus, according to the present embodiment, the subband bandwidth in frequency hopping is a natural number multiple of the RBG size in Type0 assignment. This causes the RBG configuration to be identical between subbands in Type0 assignment. That is, RBs assigned to one frequency hopping target terminal before and after frequency hopping correspond to RBs at the same positions in RBGs located by a natural number apart in Type0 assignment. For this reason, when only RBs in one RBG are assigned to the frequency hopping terminal before frequency hopping, only RBs in one RBG are also necessarily assigned after frequency hopping. That is, if only RBs in one RBG are assigned before frequency hopping, RBs are never assigned over a plurality of RBGs after frequency hopping. Therefore, the present embodiment can reduce the number of RBGs occupied in Type0 assignment by the frequency hopping terminal and flexibly assign resources in Type0 assignment.

### Embodiment 2

When one frequency hopping terminal is assigned over a plurality of subbands before frequency hopping in the above-described band to which frequency hopping is applied, the frequency hopping terminal may be assigned to a non-continuous transmission band after frequency hopping. For example, in above FIG. 5, suppose a data signal of the frequency hopping terminal is assigned to three continuous RBs of RB#33 (subband #2), RB#34 (subband #3) and RB#35 (subband #3). In this case, assuming that the frequency hopping terminal frequency-hops by one subband (9 RBs), the data signal of the frequency hopping terminal after frequency hopping is assigned to three non-continuous RBs of RB#42 (subband #3), RB#7 (subband #0) and RB#8 (subband #0). However, the LTE specification does not allow non-continuous assignment of the data signal to be performed. For this reason, the frequency hopping terminal is required to satisfy the constraint that no data signal should be assigned over a plurality of subbands (subband-related constraint).

Furthermore, according to Embodiment 1 (FIG. 5), when only RBs in one RBG in Type0 assignment are assigned to a frequency hopping terminal before frequency hopping (that is, RBs are not assigned over a plurality of RBGs), only RBs in one RBG in Type0 assignment are assigned even after frequency hopping. However, when RBs are assigned to the frequency hopping terminal over a plurality of RBGs in Type0 assignment before frequency hopping, RBs are also assigned over a plurality of RBGs in Type0 assignment after frequency hopping. That is, in Embodiment 1, the frequency hopping terminal is required to satisfy the constraint that no data signal should be assigned over a plurality of RBGs before frequency hopping (RBG-related constraint).

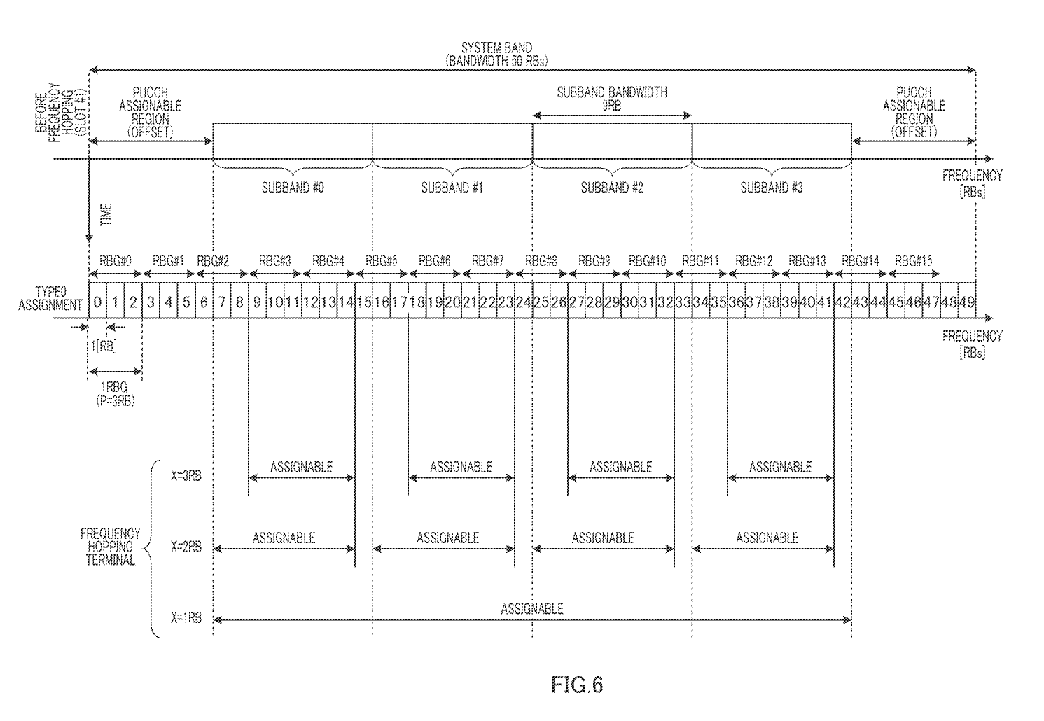

Thus, when both the above-described subband-related constraint and RBG-related constraint are taken into consideration, RBs assignable to the frequency hopping terminal are limited to only some RBs illustrated in FIG. 6. To be more specific, as illustrated in FIG. 6, a case will be described where X (X=1 to 3) RBs are assigned before frequency hopping as the transmission band of a data signal of the frequency hopping terminal. As illustrated in FIG. 6, when X=1 RB, the data signal can be assigned without considering the above-described constraints.

On the other hand, when X=2 RBs, the data signal is not assigned to RB#15 located on the boundary between subbands #0 and #1 and located on the boundary between RBGs#4 and #5. Furthermore, the same applies to RB#24 located on the boundary between subbands #1 and #2 and located on the boundary between RBGs#7 and #8, and RB#33 located on the boundary between subbands #2 and #3 and located on the boundary between RBGs#10 and #11. Furthermore, no data signal is assigned to RB#42 located at the tail end of sub band #3 and located on the boundary between RBGs#13 and #14 either.

Furthermore, when X=3 RBs, the data signal is not assigned to RBGs at both ends of 9 RBs [last 2 RBs, all 3 RBs, all 3 RBs, first 1 RB] over 4 RBGs in Type0 assignment making up one subband. That is, in subband #0 illustrated in FIG. 6, only RBs#9 to #14 corresponding to RBGs#3 and #4 are assignable to the frequency hopping terminal and in subband #1, only RBs#18 to #23 corresponding to RBGs#6 and #7 are assignable. The same applies to subbands #2 and #3 illustrated in FIG. 6. However, for also assignable RBs illustrated in FIG. 6, to reduce the number of RBGs occupied by the frequency hopping terminal, there still remains a constraint that assigned RBs within the RBG size should not be assigned over a plurality of RBGs.

Thus, RBs should be assigned not over a plurality of subbands nor over a plurality of RBGs in Type0 assignment to the data signal of the frequency hopping terminal. In this case, there is a problem that when the base station assigns RBs to the frequency hopping terminal, RBs assignable in a band to which frequency hopping is applied are limited.

Thus, the base station according to the present embodiment causes one of a plurality of boundaries between RBGs to coincide with a plurality of boundaries between subbands and assigns a plurality of RBs to the non-continuous band assignment target terminal apparatus in RBG units. When assigning RBs to the frequency hopping terminal, this prevents RBs assignable in the band to which frequency hopping is applied from being limited.

Hereinafter, the present embodiment will be described more specifically.

In base station 100 (FIG. 3) according to the present embodiment, assignment section 1102 of scheduling section 110 assigns a plurality of RBs making up the system band to the non-continuous band assignment target terminal apparatus in RBG units as in the case of Embodiment 1. However, assignment section 1102 assigns a plurality of RBs to the non-continuous band assignment target terminal in RBG units by causing one of a plurality of boundaries between RBGs in Type0 assignment to coincide with a plurality of boundaries between subbands in frequency hopping. For example, assignment section 1102 causes the frequency position at an end of one low-frequency side (or high-frequency side) of a plurality of RBGs to coincide with the frequency position at an end on the low-frequency side (or high-frequency side) of the band to which frequency hopping is applied. In this way, assignment section 1102 assigns RBs to the non-continuous band assignment target terminal using a plurality of RBGs set so that a plurality of boundaries between RBGs in Type0 assignment coincide with a plurality of boundaries between subbands in frequency hopping. To be more specific, the above-described boundary between subbands is a boundary between subbands assuming a case where the subband bandwidth is a natural number multiple of RBG size P.

On the other hand, in terminal 200 according to the present embodiment (FIG. 4), when resource assignment to the terminal is non-continuous band assignment (that is, terminal 200 is a non-continuous band assignment target terminal), assigned RB determination section 208 determines RBs assigned to the terminal (assigned RBs) based on resource assignment information (bitmap) inputted from decoding section 204 as in the case of Embodiment 1. As in the case of assignment section 1102 according to the present embodiment, assigned RB determination section 208 determines assigned RBs using a plurality of RBGs set so that a plurality of boundaries between RBGs in Type0 assignment coincide with a plurality of boundaries between subbands in frequency hopping. To be more specific, suppose the above-described boundary between subbands is a boundary between subbands assuming a case where the subband bandwidth is a natural number multiple of RBG size P.

Next, operations of base station 100 (FIG. 3) and terminal 200 (FIG. 4) according to the present embodiment will be described.

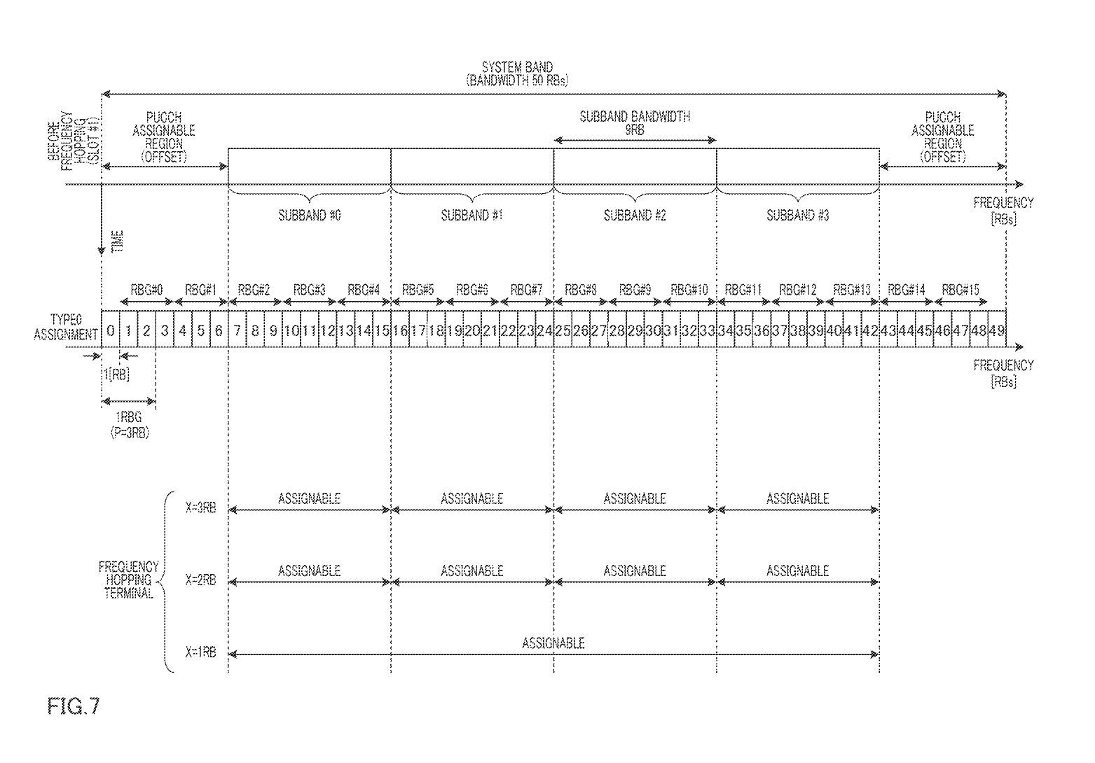

In the following descriptions, as illustrated in FIG. 7, suppose the bandwidth of the system band is 50 RBs (e.g., 10 MHz) as in the case of Embodiment 1 (FIG. 5). Furthermore, suppose RBG size P in Type0 assignment is 3 RBs.

Furthermore, setting section 1101 of scheduling section 110 of base station 100 sets a band to which frequency hopping is applied to 36 RBs (=50 RBs−(7 RBs×2)) (RBs#7 to #42) as in the case of Embodiment 1. Furthermore, setting section 1101 uniformly divides the band (36 RBs) to which frequency hopping is applied into four subbands #0 to #3 each having a bandwidth of 9 RBs as in the case of Embodiment 1. That is, each bandwidth (9 RBs) of subbands #0 to #3 illustrated in FIG. 7 is a natural number multiple of (3 times) RBG size P (3 RBs) as in the case of Embodiment 1.

Thus, assignment section 1102 sets RBGs so that a plurality of boundaries between RBGs coincide with the boundaries between four subbands #0 to #3 first. For example, as illustrated in FIG. 7, assignment section 1102 adjusts the frequency positions of RBGs so that the frequency position at an end on the low-frequency side of one of the plurality of RBGs coincides with the frequency position at an end on the low-frequency side of the band to which frequency hopping is applied (that is, the frequency position at an end on the low-frequency side of subband #1). To be more specific, as illustrated in FIG. 7, assignment section 1102 adjusts the frequency positions of RBGs so that the frequency position at an end on the low-frequency side of RBG#2 coincides with RB#7 which is the frequency position at an end on the low-frequency side of the band to which frequency hopping is applied. Thus, as illustrated in FIG. 7, assignment section 1102 groups RBs#1 to #48 into RBGs #0 to #15 for every three (=P) RBGs in order starting from RB#1.

Thus, as illustrated in FIG. 7, the boundary between subbands #0 and #1 coincides with the boundary between RBGs #4 and #5 (between RBs#15 and #16), the boundary between subbands #1 and #2 coincides with the boundary between RBGs #7 and #8 (between RBs#24 and #25) and the boundary between subbands #2 and #3 coincides with the boundary between RBGs #10 and #11 (between RBs#33 and #34). Furthermore, as illustrated in FIG. 7, the frequency positions at both ends of the band to which frequency hopping is applied also coincide with one of a plurality of boundaries between RBGs (between RBGs #1 and #2, and between RBGs #13 and #14 in FIG. 7).

When resource assignment of the terminal is non-continuous band assignment (when terminal 200 is a non-continuous band assignment target terminal), assigned RB determination section 208 of terminal 200 (FIG. 4) sets RBGs so that a plurality of boundaries between RBGs coincide with the boundary between four subbands #0 to #3 as in the case of assignment section 1102.

Here, in FIG. 7, the bandwidth (9 RBs) of the subband is a natural number multiple of (3 times) RBG size P (3 RBs) as in the case of Embodiment 1. Therefore, when the frequency position at an end on the low-frequency side of one of a plurality of RBGs coincides with the frequency position at an end on the low-frequency side of the band to which frequency hopping is applied, all of the plurality of boundaries between subbands always coincide with any one of the plurality of boundaries between RBGs. In other words, RBGs in Type0 assignment are not set over any RBs corresponding to a subband in frequency hopping. For example, in FIG. 7, 9 RBs making up each subband in frequency hopping correspond to 9 RBs (=3 RBs×3 RBGs) included in three RBGs in Type0 assignment.

That is, when a plurality of boundaries between subbands are made to coincide with a plurality of boundaries between RBGs, the location where the above subband-related constraint occurs (e.g., between subbands #0 and #1 illustrated in FIG. 7) always coincides with the location where the above RBG-related constraint occurs (e.g., between RBGs#4 and #5 illustrated in FIG. 7). Even when the aforementioned subband-related constraint and RBG-related constraint exist, this allows base station 100 to assign RBs to the frequency hopping target terminal by taking only the RBG-related constraint into consideration.

Therefore, as illustrated in FIG. 7, whatever transmission band X (X=1 RB to 3 RBs) of the data signal of the frequency hopping terminal may be, the data signal can be assigned to any RBs in the subband before frequency hopping. However, even for assignable RBs in each subband illustrated in FIG. 7, there is a constraint that assigned RBs within RBG size P (=3 RBs) should not be assigned over a plurality of RBGs to reduce the number of RBGs occupied by the frequency hopping terminal.

Furthermore, in FIG. 7, the bandwidth (9 RBs) of subbands #0 to #3 is a natural number multiple of (3 times) RBG size P (3 RBs) as in the case of Embodiment 1. Therefore, a data signal assigned so as to occupy only one RBG before frequency hopping is assigned so as to occupy only one RBG after frequency hopping, too. By this means, when RBs are assigned in one RBG in Type0 assignment to the frequency hopping terminal before frequency hopping, RBs are not assigned over a plurality of RBGs after frequency hopping either, making it possible to reduce the number of RBGs occupied as in the case of Embodiment 1.

In this way, the base station and terminal of the present embodiment cause a plurality of boundaries between RBGs in Type0 assignment to coincide with a plurality of boundaries between subbands in frequency hopping. That is, since all of a plurality of boundaries between subbands coincide with a plurality of boundaries between RBGs, the base station can assign RBs within the band to which frequency hopping is applied to the frequency hopping terminal according to only the RBG-related constraint without taking the aforementioned subband-related constraint into consideration. That is, since the constraint of RBs assignable to the frequency hopping terminal can be reduced, resources can be flexibly assigned to the frequency hopping terminal. Furthermore, as in the case of Embodiment 1, the present embodiment can reduce the number of RBGs occupied by the frequency hopping terminal in Type0 assignment and flexibly assign resources in Type0 assignment.

A case has been described in the present embodiment where as illustrated in FIG. 7, the frequency position at an end on the low-frequency side of RBG#2 is made to coincide with RB#7 which is the frequency position at an end on the low-frequency side of the band to which frequency hopping is applied. However, the present invention only requires that one of a plurality of boundaries between RBGs should coincide with one of a plurality of boundaries between subbands (or an end of the band to which frequency hopping is applied). For example, in FIG. 7, the frequency position at an end on the low-frequency side of RBG#5 (or RBG#8, #11) may be made to coincide with RB#16 (or RB#25, #34) which is the frequency position at an end on the low-frequency side of subband #1 (or subband #2, #3).

On the other hand, in the present invention, the frequency position at an end on the high-frequency side of one of a plurality of RBGs may also be made to coincide with the frequency position at an end on the high-frequency side of the band to which frequency hopping is applied (or frequency position at an end on the high-frequency side of a subband). For example, in FIG. 7, the frequency position at an end on the high-frequency side of RBG#4 (or RBG#7, #10, #13) may be made to coincide with RB#15 (or RB#24, #33, #42 (#42 is the frequency position at an end on the high-frequency side of the band to which frequency hopping is applied)) which is the frequency position at an end on the high-frequency side of subband #0 (or subband #1, #2, #3).

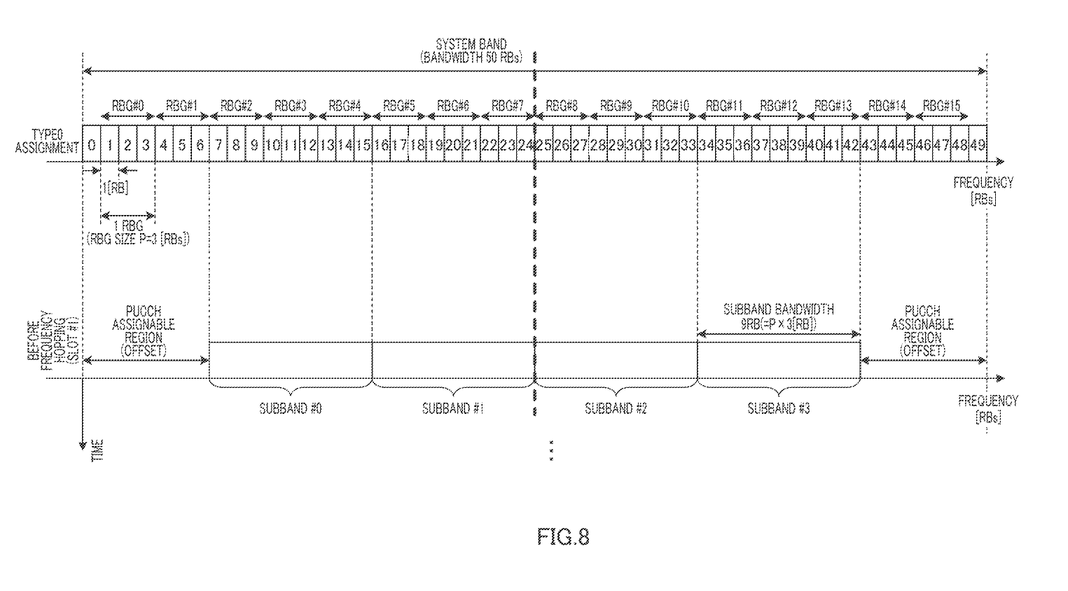

Furthermore, when the number of subbands in frequency hopping is an even number in the present invention, one of a plurality of boundaries between RBGs in Type0 assignment may be made to coincide with the center of the system band. For example, as illustrated in FIG. 8, suppose the bandwidth of the system band is 50 RBs (e.g., 10 MHz) as in the case of the present embodiment (FIG. 7), RBG size P in Type0 assignment is 3 RBs and the number of subbands is 4 (that is, an even number). In this case, the base station and terminal set subbands #0 to #3 in frequency hopping as in the case of the present embodiment. Furthermore, the base station and terminal adjust the frequency positions of RBGs so that one of RBG boundaries (between RBGs#7 and #8 in FIG. 8) in Type0 assignment coincides with the center of the system band (between RBs#24 and #25 in FIG. 8). For example, as the band to which frequency hopping is applied, LTE assigns a band so that portions extending from the center of the system band to both sides have the same bandwidth. To be more specific, in FIG. 8, 18 RBs (RBs#7 to #24) are assigned from the center of the system band toward the low-frequency side and 18 RBs (RBs#25 to #42) are assigned from the center of the system band toward the high-frequency side. Therefore, LTE sets subbands symmetrically on both sides of the center of the system band (that is, an even number of subbands are set as a whole) and a boundary of subbands is always set at the center of the system band. That is, when the number of subbands in frequency hopping is an even number, the center of the system band coincides with the boundary of subbands. Therefore, causing one of a plurality of boundaries between RBGs to coincide with the center of the system band is equivalent to causing one of a plurality of boundaries between RBGs to coincide with a plurality of boundaries between subbands. Effects similar to those in the present embodiment can be obtained in this case, too. There is a high possibility that 4 (even number) may be used as the number of subbands and the present invention may design a format of Type0 assignment of the present invention assuming only a case where the number of subbands is an even number to optimize cases where the number of subbands is an even number. That is, the base station and terminal may always use a format of the same Type0 assignment irrespective of whether the number of subbands is an even number or odd number. For example, irrespective of whether the number of subbands is an even number or odd number, the boundary of RBGs in Type0 assignment may be made to coincide with the center of the system band. This eliminates the necessity for the base station and terminal to change processing related to Type0 assignment according to the number of subbands. Here, since the possibility that the number of sub bands may be an odd number is low, in the case where the number of subbands is an odd number, influences on the entire system would be small when it is not possible to obtain effects that might be produced if the aforementioned number of subbands is an even number.

Furthermore, a case has been described in the present embodiment where when the subband bandwidth is three times RBG size P, one of a plurality of boundaries between RBGs is made to coincide with a plurality of boundaries between subbands. However, the present invention is not limited to a case where the subband bandwidth is three times RBG size P. For example, the base station may cause one of a plurality of boundaries between RBGs to coincide with a plurality of boundaries between subbands while setting the subband bandwidth such that the band to which frequency hopping is applied becomes largest within the bandwidth of the system band among the bandwidths of subbands corresponding to natural number multiples of RBG size P. In this case, as in the case of the present embodiment, it is possible to improve flexibility of resource assignment in Type0 assignment and further maximize frequency diversity effects by frequency hopping.

Furthermore, in the present embodiment, when there are RBs (remaining RBs) that can no longer make up RBGs at both ends of the system band due to an adjustment of frequency positions of RBGs, the base station may group RBs at both ends (remaining RB group) into one RBG. For example, in FIG. 7, RBs#0 and #49 are remaining RBs which are included in none of RBGs. Thus, the base station may newly set one RBG including RBs#0 and #49 and perform resource assignment in RBG units in the same way as other RBGs #0 to #15. Thus, the base station can notify a plurality of remaining RBs to the terminal in RBG units and thereby suppress increases in the amount of signaling.

Alternatively, the base station may also group remaining RBs located at both ends of the system band into one RBG for each of RBs at both ends of the system band. This allows the base station to assign resources of remaining RBs at both ends of the system band independently as different RBGs and further improve flexibility of resource assignment. Alternatively, of remaining RBs located at both ends of the system band, the base station may group RBs located at one end into one RBG to assign resources in RBG units but assign resources in RB units for RBs at the other end without grouping RBs into one RBG. This allows the base station to suppress increases in the amount of signaling by notifying resource assignment information to the terminal in RBG units on one hand, and improve flexibility of resource assignment by assigning resources in RB units on the other. The base station may not group any remaining RBs located at both ends of the system band into one RBG nor perform resource assignment. In LTE, it is assumed that PUCCH regions are more likely to be assigned to RBs located at both ends of the system band and resources are less likely to be assigned thereto. Therefore, the amount of signaling in resource assignment can be reduced by excluding all remaining RBs located at both ends of the system band as resource assignment targets.

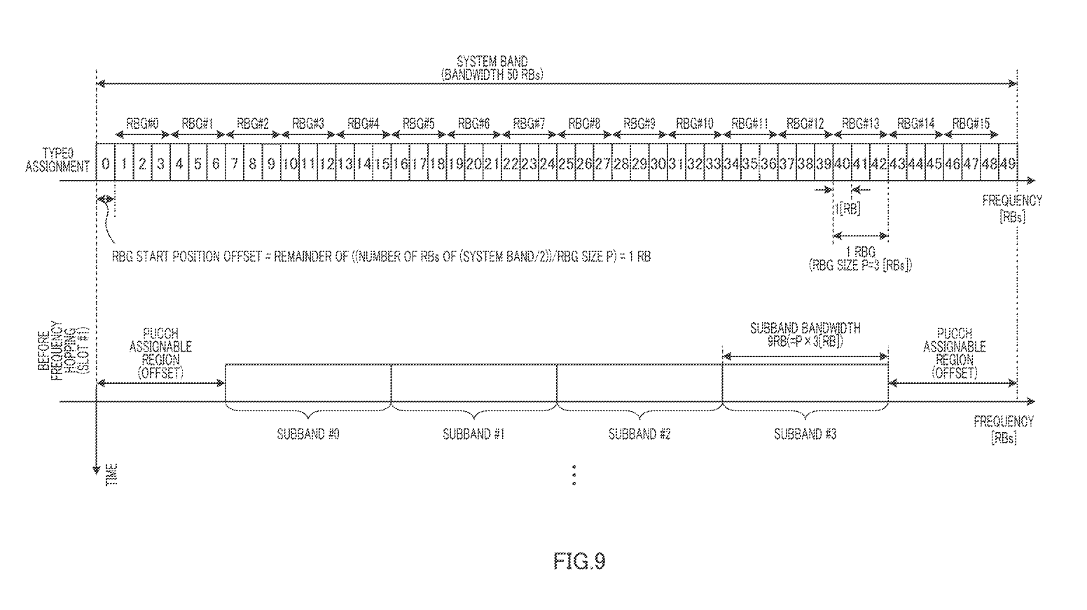

Furthermore, the base station and terminal in the present invention may also calculate an offset (hereinafter referred to as “RBG start position offset”) to determine the start position of RBG (that is, start position of the start RBG) based on the number of RBs making up the system band and RBG size P. For example, the base station and terminal designate the remainder of ((the number of RBs making up the system band/2)/RBG size P) as an RBG start position offset. This means that RBGs of RBG size P are repeatedly assigned from the center of the system band toward both ends of the system band and RBs (RBs of less than RBG size P) (remainder) that cannot make up RBGs of RBG size P at both ends of the system band correspond to the RBG start position offset. That is, the base station and terminal shift the start position of the start RBG out of a plurality of RBGs by RBs corresponding to the remainder of ((half the number of RBs making up the system band)/RBG size P) from the first frequency position of the system band. To be more specific, as illustrated in FIG. 9, when it is assumed that the bandwidth of the system band is 50 RBs and RBG size P is 3 RBs, the RBG start position offset is 1 RB, which is the remainder of 25/3. Thus, the base station and terminal shift the start position of RBG by the RBG start position offset (1 RB) from the start of the system band as illustrated in FIG. 9. The base station and terminal then group RBs for every 3 RBs in order starting from RB#1 and set RBGs #0 to #15. In this case, as illustrated in FIG. 9, all boundaries between a plurality of subbands coincide with one of boundaries of a plurality of RBGs as in the case of the present embodiment. (Remainder of (half the number of RBs making up the system band)/RBG size P))+(multiple of RBG size P) may also be used as the RBG start position offset.

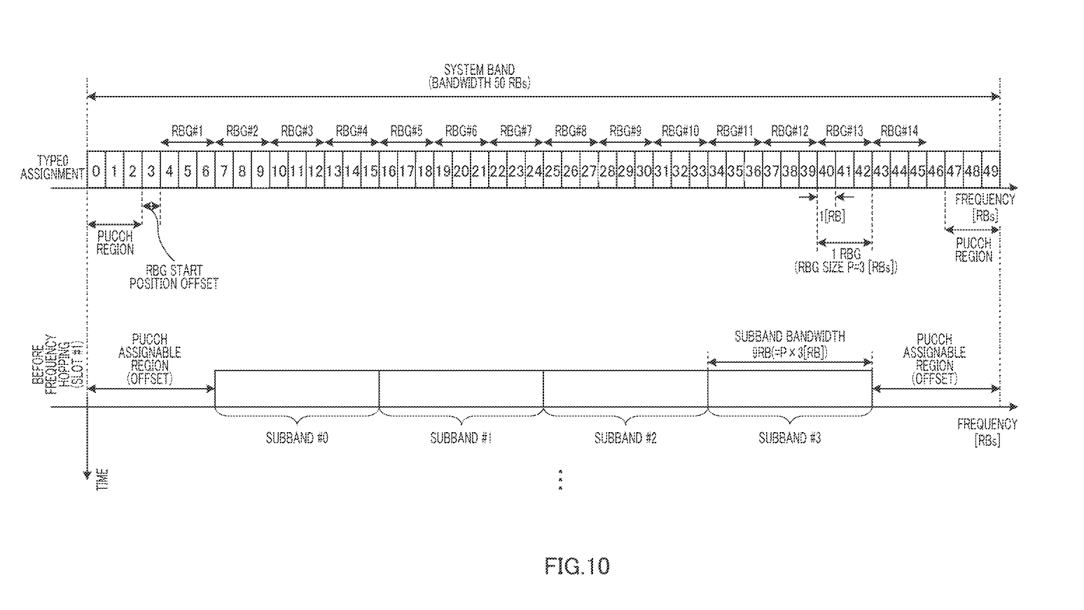

Furthermore, the base station and terminal in the present invention may also calculate the RBG start position offset by taking the PUCCH regions into consideration. For example, the base station and terminal may designate the remainder of ((the number of RBs making up the system band−the number of RBs making up the PUCCH region)/2)/RBG size P) as the RBG start position offset. This means that RBGs of RBG size P are repeatedly assigned from the center of the system band toward both ends of the system band and RBs (RBs of less than RBG size P) (remainder) that cannot make up RBGs of RBG size P at both ends of the band (system band−PUCCH regions) other than PUCCH regions (both end portions of the system band) of the system band correspond to the RBG start position offset. That is, the base station and terminal shift the start position of the start RBG out of a plurality of RBGs by RBs corresponding to the remainder of ((half (the number of RBs making up the system band−the number of RBs making up the PUCCH regions))/RBG size P) from the frequency positions of the PUCCH regions. To be more specific, as illustrated in FIG. 10, a case will be described where it is assumed that the system band is 50 RBs, RBG size P is 3 RBs and the PUCCH regions have 3 RBs at each of both ends of the system band (that is, total 6 RBs). In this case, the RBG start position offset becomes 1 RB which is the remainder of ((50-6)/2)/3. Thus, the base station and terminal shift the start position of RBG by the RBG start position offset (1 RB) from the frequency position of the PUCCH region (RB#2 in FIG. 10) as illustrated in FIG. 10. The base station and terminal then group RBs for every 3 RBs in order starting from RB#4 and set RBGs #0 to #15. In this case, as illustrated in FIG. 10, all of a plurality of boundaries between subbands coincide with one of a plurality of boundaries between RBGs as in the case of the present embodiment. Furthermore, in FIG. 10, it is possible to prevent RBGs from being set in the PUCCH regions. As the RBG start position offset, ((the remainder of (half (the number of RBs making up the system band−the number of RBs making up the PUCCH regions)/RBG size P))+(multiple of RBG size P) may also be used.

A case has been described in above FIG. 9 and FIG. 10 where the RBG start position offset is fixed. However, in the present invention, the base station is only required to maintain a plurality of RBG start position offsets, select one of the plurality of RBG start position offsets and notify the selected RBG start position offset to the terminal.

Furthermore, in the present invention, all possible values equal to or more than 0 RBs and less than RBG size P (that is, P types) may be used as the RBG start position offset. This allows the base station to adjust the start position of RBG by the RBG size. That is, the base station can set RBGs to any frequency positions. For this reason, whatever the plurality of boundaries between subbands may be, the base station can reliably cause one of the plurality of boundaries between RBGs to coincide with the boundary between subbands by adjusting the RBG start position offset. Thus, whatever the plurality of boundaries between subbands may be, the base station can improve flexibility of resource assignment to the frequency hopping terminal as in the case of the present embodiment.

Furthermore, in LTE, the PUCCH regions are assigned at both ends of the system band and the bandwidths of the PUCCH regions are changed according to the amount of uplink control information. That is, some RBs included in RBGs at both ends out of the plurality of RBGs in Type0 assignment may be occupied by the PUCCH regions. That is, the base station cannot assign RBGs at both ends of the plurality of RBGs to the non-continuous band assignment target terminal, resulting in a problem that flexibility of resource assignment in Type0 assignment deteriorates. Thus, in the present invention, the base station may assign RBs making up the band except the PUCCH region out of the band other than the band to which frequency hopping is applied (that is, PUCCH assignable region) in the system band, in RBG size P units or in units of RBG size different from RBG size P. That is, the base station may change the RBG size of some RBGs in a band except the PUCCH regions of the band other than the band to which frequency hopping is applied (PUCCH assignable band) (the RBG size may be greater or smaller than P).

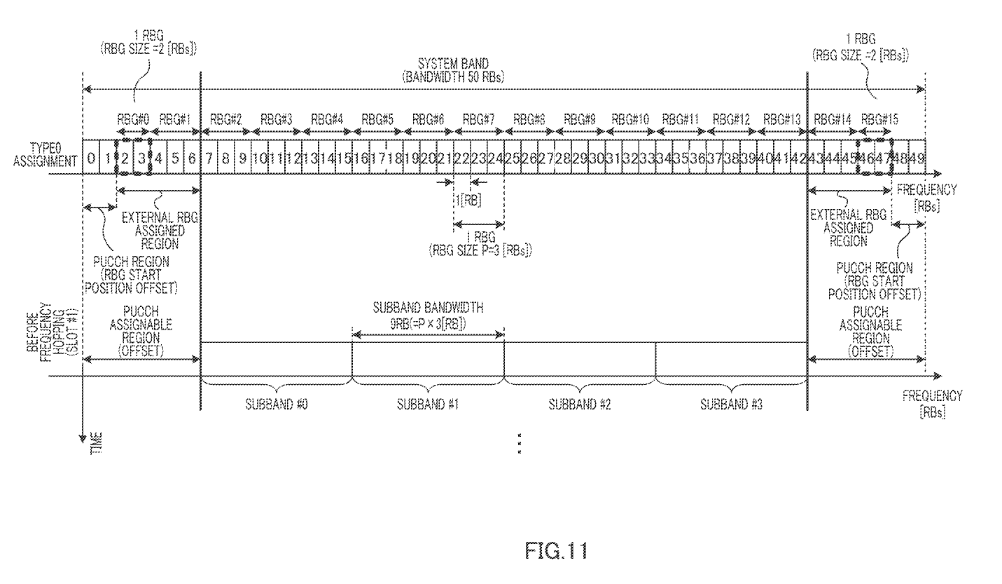

Hereinafter, as illustrated in FIG. 11, a case will be described assuming that the system band is 50 RBs, RBG size P is 3 RBs and the PUCCH regions are 2 RBs each at both ends of the system band. The base station maintains a plurality of RBG start position offsets. The base station selects one RBG start position offset corresponding to the bandwidth of the PUCCH region and notifies the selected RBG start position offset to the terminal. In FIG. 11, suppose the base station has an RBG start position offset of 2 RBs.

As illustrated in FIG. 11, irrespective of the selected RBG start position offset, the base station causes the boundary between RBGs to coincide with the boundary between subbands in the band to which frequency hopping is applied (RBs#7 to #42 illustrated in FIG. 11) as in the case of the present embodiment. Furthermore, the base station designates the band other than the PUCCH regions (RBs#0, #1, #48 and #49 illustrated in FIG. 11) of the PUCCH assignable regions (RBs#0 to RB#6, RB#43 to RB#49 illustrated in FIG. 11) which are the bands other than the band to which frequency hopping is applied as the RBG assigned region other than the band to which frequency hopping is applied (hereinafter referred to as “external RBG assigned region”). The base station then adjusts the RBG size in the external RBG assigned regions (RBs#2 to #6, RBs#43 to #47 illustrated in FIG. 11) based on the number of RBs of the external RBG assigned regions. To be more specific, as illustrated in FIG. 11, the base station groups 5 RBs of RBs#2 to #6, which is an external RBG assigned region, for every RBG size P or RBG size different from RBG size P to set RBG#1 of RBG size P (=3 RBs) and RBG#0 having an RBG size of 2 RBs (P). Similarly, as illustrated in FIG. 11, the base station groups 5 RBs of RBs#43 to #47, which is an external RBG assigned region, to set RBG#14 of RBG size P (=3 RBs) and RBG#15 having an RBG size of 2 RBs (<P).

That is, in FIG. 11, of RBGs #0 to #15, which are resource assignment targets in Type0 assignment, the base station changes the RBG size of RBG#0 and RBG#15 at both ends to a size smaller than RBG size P. As illustrated in FIG. 11, this allows the base station to prevent RBGs at both ends in Type0 assignment from being occupied by PUCCH regions. Thus, it is possible to assign all bands other than the PUCCH regions (RBs#2 to #47 in FIG. 11) of the entire system band to the non-continuous band assignment target terminal.

In other words, of RBGs #0 to #15, which are resource assignment targets in Type0 assignment, the base station changes the RBG size of RBG#0 and RBG#15 set in the band (external RBG assigned regions) other than the band to which frequency hopping is applied. Thus, as illustrated in FIG. 11, the subband bandwidth is a natural number multiple of (3 times) RBG size P within the band to which frequency hopping is applied (RBs#7 to #42) and all of the plurality of boundaries between subbands coincide with one of the plurality of boundaries between RBGs. Thus, when the RBG size of RBG is changed, it is also possible to obtain effects similar to those of the present embodiment in the band to which frequency hopping is applied (RBs#7 to #42) illustrated in FIG. 11.

Furthermore, in FIG. 11, of the external RBG assigned regions, RBs included in RBGs (RBGs #0 and #15 illustrated in FIG. 11) whose RBG size is changed are equivalent to RB (1 RB of RB#3 in FIG. 10) corresponding to the RBG start position offset in above FIG. 10. That is, the base station may set RBs corresponding to the RBG start position offset in FIG. 10 as one RBG.

Furthermore, in FIG. 11, a case has been described as an example where the base station sets RBGs by reducing the RBG size in external RBG assigned regions. However, in the present invention, the base station may set RBGs by increasing the RBG size in the external RBG assigned regions. For example, in FIG. 11, the base station groups RBs#2 to #6 (or RBs#43 to #47), which is an external RBG assigned region, to set one RBG whose RB size is 5 RBs (>RBG size P).

Furthermore, a case has been described in the present embodiment where the subband bandwidth is a natural number multiple of RBG size P. However, irrespective of whether or not the subband bandwidth is set to a natural number multiple of RBG size P, the present invention may also cause the RBG boundary to always coincide with the subband boundary in the case where the subband bandwidth becomes a natural number multiple of RBG size P. Thus, the base station and terminal can always use the same Type0 assignment format. The base station and terminal can then select whether or not to apply the present invention by controlling the subband bandwidth.

### Embodiment 3

In the present embodiment, the base station and terminal define the RBG format in Type0 assignment in sub band units in frequency hopping.

Hereinafter, the present embodiment will be described more specifically.

In base station 100 (FIG. 3) according to the present embodiment, setting section 1101 of scheduling section 110 sets PUCCH assignable regions and the number of a plurality of subbands making up a band to which frequency hopping is applied and determines the band to which frequency hopping is applied and the subband bandwidth. However, the subband bandwidth obtained by dividing the band to which frequency hopping is applied may or may not be a natural number multiple of RBG size P in Type0 assignment. That is, setting section 1101 sets the PUCCH assignable region and number of subbands to arbitrary values.

Assignment section 1102 of scheduling section 110 defines an RBG format in Type0 assignment that coincides with the number of RBs corresponding to the subband bandwidth determined in setting section 1101. For example, assignment section 1102 defines the RBG format by grouping the number of RBs corresponding to the subband bandwidth for every RBG size P. When the subband bandwidth is a natural number multiple of RBG size P, assignment section 1102 defines a format made up of (subband bandwidth/RBG size P) RBGs. On the other hand, when the subband bandwidth is not a natural number multiple of RBG size P, assignment section 1102 defines a format by changing the RBG size of some RBGs of a plurality of RBGs according to the subband bandwidth. For example, assignment section 1102 defines a format made up of the same number of RBGs as the quotient of (the subband bandwidth/RBG size P) having RBG size P and one RBG having the same RBG size as the remainder of (the sub band bandwidth/RBG size P).

Furthermore, assignment section 1102 sets a plurality of RBGs throughout the entire system band by repeating the defined format in order starting from the start frequency position of the system band. Assignment section 1102 assigns a plurality of RBs making up the system band in RBG units to a non-continuous band assignment target terminal apparatus as in the case of Embodiment 1.

On the other hand, in terminal 200 (FIG. 4) according to the present embodiment, when resource assignment to the terminal is non-continuous band assignment (that is, when terminal 200 is a non-continuous band assignment target terminal), assigned RB determination section 208 determines RBs assigned to the terminal (assigned RBs) based on resource assignment information (bitmap) inputted from decoding section 204 as in the case of Embodiment 1. However, as in the case of assignment section 1102 according to the present embodiment, assigned RB determination section 208 defines an RBG format in Type0 assignment that coincides with the number of RBs corresponding to the subband bandwidth, repeats the defined format in order starting from the start frequency position of the system band and thereby sets a plurality of RBGs throughout the entire system band.

Next, operations of base station 100 (FIG. 3) and terminal 200 (FIG. 4) according to the present embodiment will be described in detail.

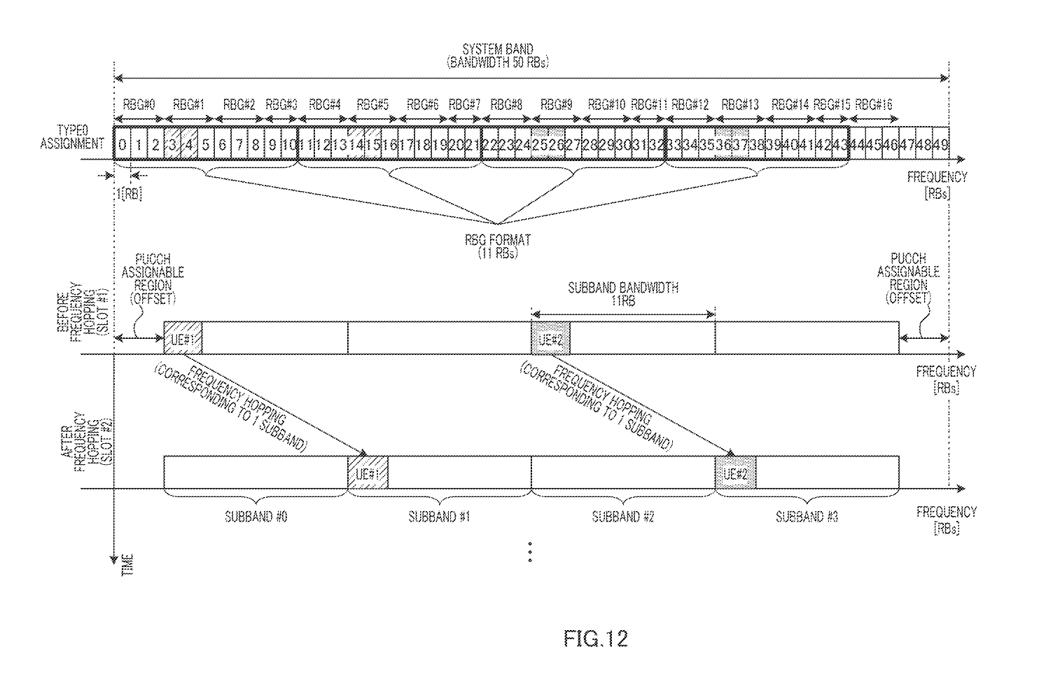

In the following descriptions, as illustrated in FIG. 12, suppose the bandwidth of the system band is 50 RBs (e.g., 10 MHz) as in the case of Embodiment 1 (FIG. 5). Furthermore, suppose RBG size P in Type0 assignment is 3 RBs.

Furthermore, setting section 1101 of scheduling section 110 of base station 100 assumes that the PUCCH assignable region is 3 RBs and the number of subbands is four. Thus, setting section 1101 sets the band to which frequency hopping is applied to 44 RBs (=50 RBs−(3 RBs×2)) (RBs#3 to #46).

Furthermore, setting section 1101 uniformly divides the band to which frequency hopping is applied (44 RBs) into four subbands #0 to #3 having a bandwidth of 11 RBs.

Therefore, assignment section 1102 defines an RBG format that coincides with 11 RBs corresponding to the subband bandwidth. For example, as illustrated in FIG. 12, assignment section 1102 defines a format made up of four RBGs having RBG sizes of [3 RBs, 3 RBs, 3 RBs, 2 RBs] respectively based on RBG size P=3 RBs. That is, here, as illustrated in FIG. 12, assignment section 1102 defines a format made up of 3 (=quotient of (subband bandwidth 11 RBs/RBG size 3 RBs)) RBGs having RBG size P=3 RBs and one RBG having RBG size 2 RBs (=remainder of (subband bandwidth 11 RBs/RBG size 3 RBs)).

As illustrated in FIG. 12, assignment section 1102 repeats the defined format in order starting from frequency position RB#0 at the start of the system band to thereby set a plurality of RBGs#0 to #15 throughout the entire system band. That is, as illustrated in FIG. 12, four RBGs having RBG sizes of [3 RBs, 3 RBs, 3 RBs, 2 RBs] are set in all RBs#0 to #10, RBs#11 to #21, RBs#22 to #32 and RBs#33 to #43. In other words, in RBs#0 to #43 illustrated in FIG. 12, a format made up of four RBGs having RBG sizes of [3 RBs, 3 RBs, 3 RBs, 2 RBs] is repeatedly set at intervals of the subband bandwidth (11 RBs). In FIG. 12, RBG#16 (RBs#44 to #46) is set as RBG other than RBGs set in the defined format.

Furthermore, when resource assignment of the terminal is non-continuous band assignment (when terminal 200 is a non-continuous band assignment target terminal), assigned RB determination section 208 of terminal 200 (FIG. 4) defines an RBG format that coincides with 11 RBs corresponding to the subband bandwidth as in the case of assignment section 1102.

For example, as illustrated in FIG. 12, a case will be described where base station 100 assigns RBs#3 and #4 (corresponding to first 2 RBs of RBG#1) to frequency hopping terminal UE#1 before frequency hopping (slot #1 illustrated in FIG. 12) and assigns RBs#25 and #26 to frequency hopping terminal UE#2. In this case, UE#1 is assigned to RBs#14 and #15 after frequency hopping (slot #2 illustrated in FIG. 12). Here, RBs#3 and #4 before frequency hopping correspond to first 2 RBs of RBG#1, which is the second RBG from the start of the defined format. Furthermore, RBs#14 and #15 after frequency hopping correspond to first 2 RBs of RBG#5, which is the second RBG from the start of the defined format.

That is, as in the case of Embodiment 1, even when the transmission band of a data signal is frequency-hopped for every plurality of subbands (frequency-hopped by RBs corresponding to one subband (11 RBs) in FIG. 12), the RB positions in RBG to which the data signal is assigned before frequency hopping are identical to the RB positions in RBG to which the data signal is assigned after frequency hopping. That is, in FIG. 12, RBs assigned to UE#1 before and after frequency hopping occupy RBG set at the same position (here, the second position) in the format. The same applies to UE#2 illustrated in FIG. 12. In other words, the positions of RBs to which the data signal is assigned before and after frequency hopping are the same positions in two RBGs located apart by a defined format length (11 RBs in FIG. 12) in Type0 assignment.

That is, the data signal assigned so as to occupy only 1 RBG before frequency hopping is also assigned so as to occupy only 1 RBG after frequency hopping. Thus, when RBs are assigned to the frequency hopping terminal before frequency hopping within 1 RBG in Type0 assignment, it is possible to reduce the number of RBGs occupied without extending over a plurality of RBGs after frequency hopping.

In this way, the present embodiment defines an RBG format made up of a number of RBs that matches the subband bandwidth. Thus, the RBG configuration in Type0 assignment becomes identical between subbands. That is, RBs assigned to one frequency hopping target terminal before and after frequency hopping correspond to RBs at the same positions in another RBG located apart by a defined format in Type0 assignment. Thus, when only RBs in 1 RBG are assigned to the frequency hopping terminal before frequency hopping, only RBs in 1 RBG are always assigned even after frequency hopping as in the case of Embodiment 1. Thus, according to the present embodiment, as in the case of Embodiment 1, it is possible to reduce the number of RBGs occupied in Type0 assignment by the frequency hopping terminal and flexibly perform resource assignment in Type0 assignment.

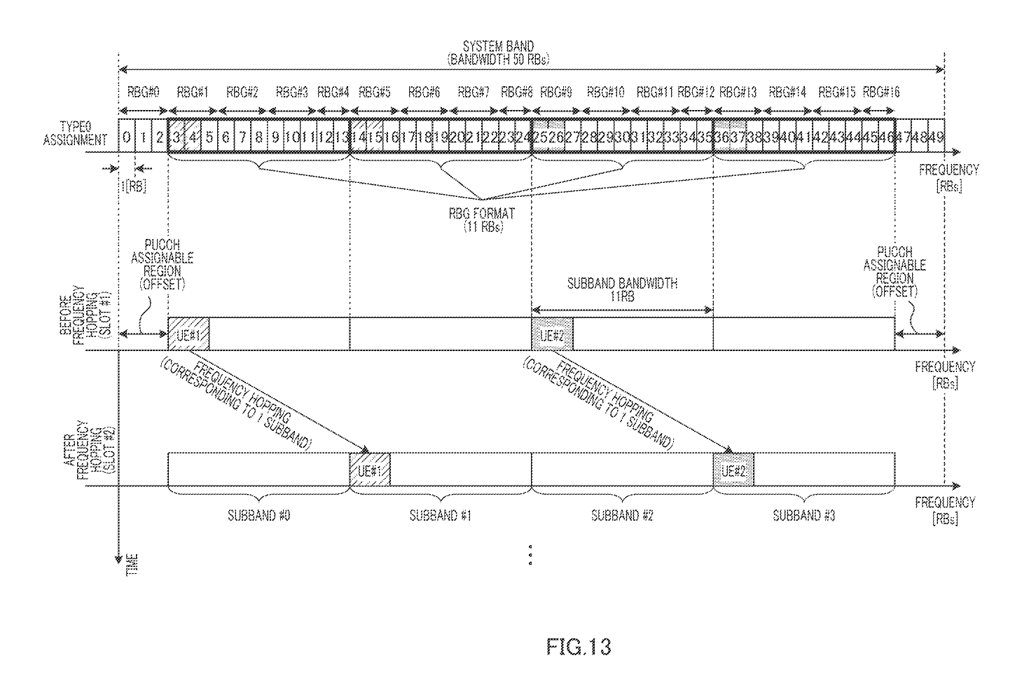

A case has been described in the present embodiment where the format is repeated in order starting from the start frequency position (RB#0 in FIG. 12) of the system band. However, in the present invention as illustrated in FIG. 13, as in the case of Embodiment 1, the base station may also cause one of a plurality of boundaries between RBGs to coincide with all boundaries between a plurality of subbands. To be more specific, as illustrated in FIG. 13, the base station may also set a plurality of RBGs by repeating a defined format in order starting from RB#3 at the frequency position at an end on the low-frequency side of the band to which frequency hopping is applied. In other words, the base station sets the format having the same bandwidth as the subband bandwidth in the same frequency band as the frequency band in which each subband is set. In this way, as in the case of Embodiment 2, one of a plurality of boundaries between RBGs can be made to coincide with all boundaries between a plurality of subbands. That is, as in the case of Embodiment 2, each RBG in Type0 assignment is no longer set over RBs corresponding to a plurality of subbands in frequency hopping. In other words, the base station can assign RBs in a band to which frequency hopping is applied according to only RBG-related constraints without taking account of subband-related constraints. That is, since constraints on RBs assignable to the frequency hopping terminal can be reduced, it is possible to flexibly assign resources to the frequency hopping terminal. In FIG. 13, RBG#0 (RBs#0 to #2) is set as RBG other than RBGs set in the defined format.

Furthermore, a case has been described in the present embodiment where RBG sizes of four RBGs making up the defined format are [3 RBs, 3 RBs, 3 RBs, 2 RBs] as illustrated in FIG. 12 and FIG. 13. However, in the present invention, the number of RBGs making up the defined format is not limited to four, but the size of RBGs in each RBG may be any value.

The embodiments of the present invention have been described so far.

A case has been described in the above embodiments where RBs are assigned in RBG units according to Type0 assignment. However, the present invention is not limited to Type0 assignment, but may also use, for example, a format in which RBs are assigned in units of P RBs. Furthermore, according to the present invention, a plurality of RBs may not necessarily be grouped into a plurality of RBGs in P [RB] units and the base station apparatus and terminal apparatus need only to share a number of RBs included in groups to which the bitmap corresponds.

Furthermore, the present invention may be applied only to a case where the bandwidth of the system band is relatively wide (e.g., when the bandwidth of the system band is 10 MHz or 20 MHz), in which case flexibility of scheduling during resource assignment can be expected to be drastically improved. Furthermore, when the bandwidth of the system band is relatively narrow (e.g., less than 10 MHz), the present invention may not be applied, whereas when the bandwidth of the system band is relatively wide (e.g., 10 MHz or above), the present invention may always be applied.

Moreover, although cases have been described with the embodiments above where the present invention is configured by hardware, the present invention may be implemented by software.

Each function block employed in the description of the aforementioned embodiment may typically be implemented as an LSI constituted by an integrated circuit. These may be individual chips or partially or totally contained on a single chip. “LSI” is adopted here but this may also be referred to as “IC,” “system LSI,” “super LSI” or “ultra LSI” depending on differing extents of integration.

Further, the method of circuit integration is not limited to LSI's, and implementation using dedicated circuitry or general purpose processors is also possible. After LSI manufacture, utilization of an FPGA (Field Programmable Gate Array) or a reconfigurable processor where connections and settings of circuit cells within an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2009-184698, filed on Aug. 7, 2009, including the specification, drawings and abstract is incorporated herein by reference in its entirety.

### INDUSTRIAL APPLICABILITY

The present invention is suitable for use in a radio communication apparatus and a radio communication method or the like in a radio communication system that assigns a data signal to a non-continuous band.

### REFERENCE SIGNS LIST

100 Base station
200 Terminal
101, 206 Coding section
102, 207 Modulation section
103, 211 RF transmission section
104, 201 Antenna
105, 202 RF reception section
106 Demultiplexing section
107, 111 DFT section
108, 112 Demapping section
109 Propagation path estimation section
110 Scheduling section
1101 Setting section
1102 Assignment section
113 Frequency domain equalization section
114 IFFT section
115, 203 Demodulation section
116, 204 Decoding section
117 Error detection section
205 CRC section
208 Assigned RB determination section
209 RB assignment section
210 Multiplexing section

1. A radio base station apparatus used in a radio communication system in which a plurality of resource blocks consisting of a system band are grouped into a plurality of resource block groups for every P resource blocks and a second band is divided into a plurality of subbands, the second band being other than a first band to which control channels assigned at both ends of the system band can be assigned, the radio base station apparatus comprising:
an assignment section that assigns the plurality of resource blocks to a terminal apparatus assigned a non-continuous band in units of the resource block groups; and
an extraction section that extracts a data signal frequency-hopped for every plurality of subbands by a frequency hopping terminal apparatus, from the plurality of resource blocks in the second band, wherein
each bandwidth of the plurality of subbands is a natural number multiple of P.

2. The radio base station apparatus according to claim 1, wherein the assignment section causes one of boundaries between the plurality of resource block groups to coincide with a boundary between the plurality of subbands and assigns the plurality of resource blocks to the terminal apparatus assigned the non-continuous band in the units of the resource block groups.

3. The radio base station apparatus according to claim 2, wherein the assignment section causes a frequency position at an end on a low-frequency side of one of the plurality of resource block groups to coincide with a frequency position at an end on a low-frequency side of the second band and assigns the plurality of resource blocks to the terminal apparatus assigned the non-continuous band in the units of the resource block groups.

4. The radio base station apparatus according to claim 2, wherein the assignment section causes a frequency position at an end on a high-frequency side of one of the plurality of resource block groups to coincide with a frequency position at an end on a high-frequency side of the second band and assigns the plurality of resource blocks to the terminal apparatus assigned the non-continuous band in the units of the resource block groups.

5. The radio base station apparatus according to claim 1, wherein the assignment section assigns resource blocks consisting of a band other than bands to which the control channels are assigned out of the first band, to the terminal apparatus assigned the non-continuous band.

6. The radio base station apparatus according to claim 5, wherein the assignment section assigns resource blocks consisting of the band other than the bands to which the control channels are assigned out of the first band, in units of resource block groups grouped by the P resource blocks or in units of resource block groups grouped by other than the P resource blocks.

7. A radio communication method used in a radio communication system in which a plurality of resource blocks consisting of a system band are grouped into a plurality of resource block groups for every P resource blocks and a second band is divided into a plurality of subbands, the second band being other than a first band to which control channels assigned at both ends of the system band can be assigned, the method comprising:
assigning the plurality of resource blocks to a terminal apparatus assigned a non-continuous band in units of the resource block groups; and
extracting a data signal frequency-hopped for every plurality of subbands by a frequency hopping terminal apparatus, from the plurality of resource blocks in the second band, wherein:
each bandwidth of the plurality of subbands is a natural number multiple of P.
